(19) United States
(12) Patent Application Publication
(10) Pub. No.: US 2018/0198388 A1
(43) Pub. Date: Jul. 12, 2018

(54) HIGH EFFICIENCY ACTUATOR FOR USE IN A MOMENTUM CONTROL DEVICE

(71) Applicant: HONEYWELL INTERNATIONAL INC., Morris Plains, NJ (US)

(72) Inventors: Thom Kreider, Peoria, AZ (US); Jon Douglas Gilreath, Peoria, AZ (US); Ronald E. Strong, Phoenix, AZ (US); Mark Villela, Glendale, AZ (US); Steven Hadden, Peoria, AZ (US)

(73) Assignee: HONEYWELL INTERNATIONAL INC., Morris Plains, NJ (US)

(21) Appl. No.: 15/608,602

(22) Filed: May 30, 2017

Related U.S. Application Data
(60) Provisional application No. 62/443,237, filed on Jan. 6, 2017.

(51) Int. Cl. H02P 6/17; H02P 6/28; B64G 1/28

(52) U.S. Cl. CPC H02P 6/17; B64G 1/283; H02P 6/28

(57) ABSTRACT

Methods and apparatus are provided for a controlled motor assembly for use in a reaction wheel assembly (RWA). The controlled motor assembly is optimized to work with an AC motor, and includes a filter configured to inhibit electrical and electromagnetic noise from being coupled between a spacecraft power bus and a power bus internal to the RWA, as well as an arrangement of power switch elements providing a path for motor phase currents associated with the AC motor. A digital control system is implemented to receive a command input, position sensor feedback and to retrieve parameters associated with the AC motor from a memory device. Based on the command input, the position sensor feedback and the parameters associated with the AC motor, the digital control system controls activation for the arrangement of power switch elements, and generates data output.

### CROSS-REFERENCE TO RELATED APPLICATIONS

This application claims the benefit of U.S. provisional patent application Ser. No. 62/443,237, filed Jan. 6, 2017.

### TECHNICAL FIELD

The present disclosure generally relates to momentum control devices and methods, and more particularly relates to motor control electronics for use in a momentum control device.

### BACKGROUND

Momentum control devices, such as control moment gyroscopes (CMGs) and reaction wheels, are commonly deployed within attitude control systems used in spacecraft, satellites, vehicles, and similar mobile platforms. A generalized momentum control device includes a rotor assembly rotatably mounted within a rotor assembly housing. The rotor assembly includes an inertial element, typically a rotating mass or an outer rim, which is fixedly coupled to a rotor shaft. During operation of a momentum control device, a motor, generally driven by a block of motor control electronics, causes the rotor assembly to rotate or spin about a spin axis. As the motor spins the rotor assembly, angular momentum is stored in the rotating inertial element. Angular momentum is then converted to torque (torque being the time derivative of angular momentum). Torque is exchanged with the spacecraft to change its attitude in space. In the course of spinning about the spin axis, the inertial element in the rotor assembly changes position, and this position may be referred to as a rotor position. To arrange three dimensional attitude control, multiple momentum control devices may be combined to form a reaction wheel array or assembly (RWA).

As satellite applications have evolved, the range of desirable satellite sizes has expanded. In particular, a field of small satellite applications has emerged that has made small satellites commercially desirable. To competitively produce efficient small satellites, all of the RWA components must reliably and efficiently scale down. In addition to smaller reaction wheels and smaller motors, a small satellite has less available real estate for the motor control electronics. The provided disclosure and embodiments address these needs as well as other design considerations.

### BRIEF SUMMARY

This summary is provided to introduce a selection of concepts in a simplified form that are further described below in the detailed description section. This summary is not intended to identify key features or essential features of the claimed subject matter, nor is it intended to be used as an aid in determining the scope of the claimed subject matter.

A motor controller for use in a reaction wheel assembly (RWA) is provided, comprising: an internal power bus filter configured to inhibit electrical and electromagnetic noise from being communicated between a spacecraft power bus associated with a spacecraft and a RWA internal power bus; an arrangement of power switch elements providing a path for motor phase currents associated with an AC motor, the arrangement of power switch elements coupled between the AC motor and the RWA power bus; a digital control system coupled to the AC motor and the arrangement of power switch elements, the digital control system configured to receive a command input, receive position sensor feedback associated with the AC motor, retrieve parameters associated with the AC motor from a memory, and based on the command input, the position sensor feedback and the parameters associated with the AC motor, (i) control activation of the arrangement of power switch elements, and (ii) generate a data output.

A controlled motor assembly for use in a reaction wheel assembly (RWA) is also provided. The controlled motor assembly comprising: a filter coupled between a spacecraft power bus associated with a spacecraft and the RWA power bus, the filter configured to inhibit communication of electromagnetic noise between the spacecraft power bus the RWA power bus; an AC motor configured to operate based on an input from the spacecraft; an arrangement of power switch elements providing a path for motor phase currents, the arrangement of power switch elements coupled to the AC motor and the power bus internal to the RWA; a digital control system coupled to the AC motor and the arrangement of power switch elements, the digital control system configured to: receive a user requested communication protocol from among a plurality of supported communication protocols, receive a command input in accordance with the user requested serial protocol, receive a position sensor feedback associated with the AC motor, retrieve parameters associated with the AC motor from a memory, and based on the command input, the position sensor feedback and the parameters associated with the AC motor, control activation for the arrangement of power switch elements, and generate a serial telemetric output or a serial command-response output.

In addition, a reaction wheel assembly (RWA) is provided, comprising: a rotor assembly; and a controlled motor assembly comprising a motor controller, an AC motor configured to operate at a first frequency, a filter coupling a spacecraft power bus associated with a spacecraft to the RWA power bus, the filter configured to inhibit electromagnetic noise at the first frequency from being coupled between the spacecraft power bus and a RWA power bus internal to the RWA; an arrangement of power switch elements coupled between the AC motor and the filter, the arrangement of power switch elements configured (i) based on the first frequency, (ii) for providing a path for motor phase currents associated with the AC motor; a digital control system coupled to the AC motor and the arrangement of power switch elements, the digital control system configured to: receive a command input in a communication protocol requested by a user from among a plurality of supported communication protocols, receive, from a position sensor, position feedback associated with the AC motor, retrieve parameters associated with the AC motor from a nonvolatile memory, and based on the command input, the position feedback and the parameters associated with the AC motor, control activation for the arrangement of power switch elements, and generate a serial telemetric output or a serial command-response output.

Other desirable features will become apparent from the following detailed description and the appended claims, taken in conjunction with the accompanying drawings and this background.

### BRIEF DESCRIPTION OF THE DRAWINGS

A more complete understanding of the subject matter may be derived from the following detailed description taken in conjunction with the accompanying drawings, wherein like reference numerals denote like elements, and wherein:

FIG. 1 is a simplified schematic block diagram of a RWA, in accordance with various embodiments;

FIG. 2 is a simplified block diagram of a controlled motor assembly for an RWA design, in accordance with various exemplary embodiments; and

FIG. 3 is a flow chart for a method for using the controlled motor assembly of FIG. 2 in a RWA.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the controlled motor assemblies in RWAs and not to limit the scope of the motor control electronics or controlled motor assemblies defined by the claims. Furthermore, there is no intention to be bound by any expressed or implied theory presented in the preceding Technical Field, Background, Brief Summary or the following Detailed Description.

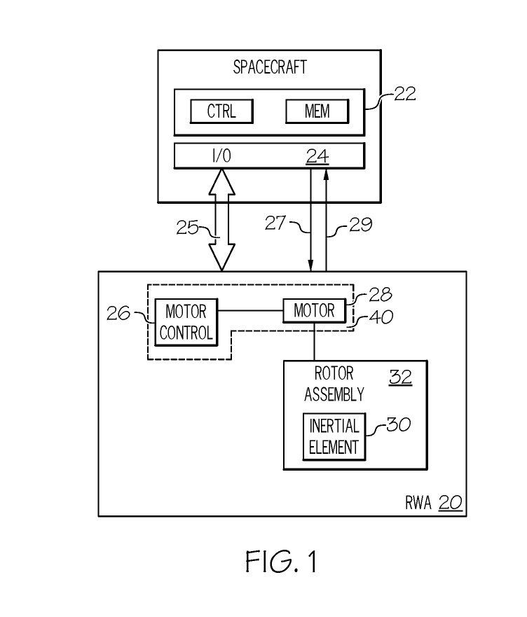

FIG. 1 depicts a simplified schematic block diagram of a RWA 20, in accordance with various embodiments. The RWA 20 may be part of a spacecraft 10 or may instead be part of a satellite or any mobile platform that utilizes momentum control devices. A spacecraft control module 22 and a multifunction input/output communication module 24 enable communication between the spacecraft 10 and the RWA 20. A spacecraft power bus 25, command input (to the RWA 20) on lead 27, and command output (from the RWA 20) on lead 29 are shown coupling the spacecraft 10 to the RWA 20. Within the RWA 20, a block of motor control electronics, motor controller 26, a motor 28, and an inertial element 30 (within a rotor assembly 32) are coupled together. Although only one motor 28 and one inertial element 30 are depicted, it is readily appreciated that, in practice, there may be more than one of the motors 28 and more than one of the respective inertial elements 30.

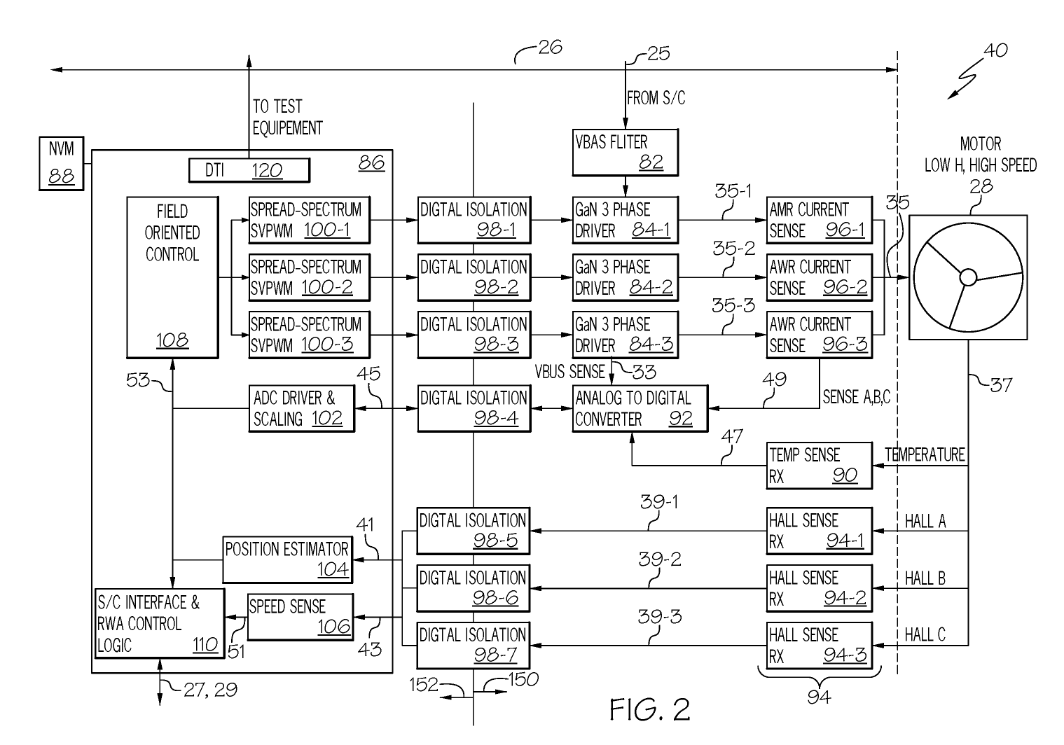

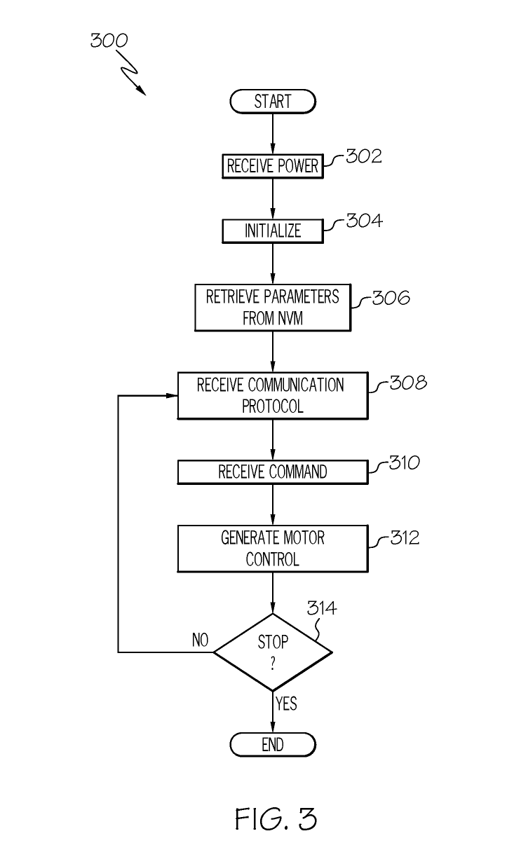

An object as contemplated herein is to combine the motor control electronics and the motor in a manner that optimizes efficiency, reliability, and scalability, in addition to reducing noise. Hereinafter, the optimized motor control electronics block is referred to as a motor controller 26, and the combination of the motor controller 26 and the motor 28 is referred to as a controlled motor assembly 40. The provided controlled motor assembly 40 is optimized to have a wide range of scalability. The provided controlled motor assembly 40 also delivers reduced cost and high efficiency while meeting the performance requirements of the small, or pico-satellite, RWA products. To this end, in various embodiments, the motor 28 (also referred to herein as an “AC motor” 28) comprises a high speed alternating current (AC) permanent magnet synchronous motor (PMSM), a permanent magnet alternating current (PMAC) motor, or any of a plurality of types of high speed alternating current (AC) motors providing the features described herein. The controlled motor assembly 40 combines the motor 28 with a motor controller 26 that maximizes digital signal processing while minimizing analog signal processing. In order to support the plurality of types of high speed alternating current (AC) motors, the controlled motor assembly 40 employs nonvolatile memory, to store therein, parameters for each respective motor 28 type. Accordingly, the controlled motor assembly 40 can (automatically, and without maintenance intervention) detect the motor 28 type, and responsive to the detection, configure timing and memory management appropriate for the detected motor 28 type. These features are described in detail in connection with FIG. 2 and FIG. 3.

With reference to FIG. 2, a controlled motor assembly 40 for an RWA 20 design is provided. FIG. 2 depicts an AC motor 28, and digital signal processing provided, in part, by a field oriented control (FOC 108). Whereas designs that utilize direct current (DC) three phase motors (such as brushless DC motors) generally require a determination to be made by the motor controller 26 as to which two thirds of the time (i.e., which two out of three phases) to run current through the DC three phase motor, the utilized AC motor 28 is configured to operate on a continuous time domain controlled alternating current (AC) waveform. The AC motor 28 receives the continuous time domain controlled alternating current (AC) waveform via node 35 (hence, AC motor 28 is configured to be driven at all times). As is described in more detail below, the motor phase current waveform on node 35 that drives the AC motor 28 is a combination of motor phase current waveforms on nodes 35-1, 35-2, and 35-3 based on one or more inputs from the spacecraft 10 (for example, lead 27 and spacecraft power bus 25). Additionally, the exemplary embodiment utilizes a digital control system 86, including the FOC 108, maximizes the use of digital electronics in the generation of the current waveform on node 35, and reduces the burden on the spacecraft control module 22, as will be described in more detail below.

In the embodiment of FIG. 2, the motor controller 26 comprises a filter 82, the digital control system 86, and an arrangement of power switch elements 84. In various embodiments, the motor controller 26 may additionally comprise one or more of: a temperature sensor 90, an analog to digital converter 92, current sensors 96, and digital isolator 98. A controlled motor assembly 40 may comprise the motor controller 26 described above and the AC motor 28.

There are several I/O terminals (plus ground) coupled to the motor controller 26. With reference to FIG. 2, the I/O terminals include (i) spacecraft power bus 25, which includes a spacecraft power bus voltage (V_{BUS}) and also allows current to travel into and out of the motor controller 26 from the spacecraft 10, (ii) a command input on lead 27, which accepts commands from the spacecraft 10; the commands may be provided using a plurality of different supported communication protocols, and (iii) a command output on lead 29. The command input on lead 27 may be used for selectively adjusting from among the plurality of different communication protocols that are supported by the digital control system 86. Selective adjustment may comprise sensing a user or system requested communication protocol (as a command input on lead 27) and adjusting timing protocols and data management protocols within the digital control system 86 accordingly, prior to commencing receiving further commands on the lead 27. In an embodiment, the lead 27 receives a user requested serial protocol and then receives input commands in accordance with the user requested serial protocol; however, in other embodiments the lead 27 receives commands in accordance with various parallel protocols. The command output on lead 29 may be a serial telemetric output or a serial command-response output, and is based on the command input on lead 27.

The AC motor 28, the digital control system 86, and the arrangement of power switch elements 84 are coupled together, and, as is described herein, their configurations are functions of each other. The AC motor 28 is configured to operate on (or be driven by) a high frequency signal (the motor phase currents on nodes 35-1, 35-2, and 35-3 collectively, motor phase currents on node 35). For the purpose of this application, “high frequency” means approximately 200 KHz or greater. The high frequency signal on node 35 is sourced from the digital control system 86, received as high frequency pulse width modulated (PWM) signals.

The digital control system 86 generates the high frequency signals (motor phase currents on nodes 35) via the pulse width modulators 100-1, 100-2, and 100-3, collectively PWM 100 (described in more detail below); these high frequency signals drive the arrangement of power switch elements 84 (switch 84-1, switch 84-2, and switch 84-3), which results in the motor phase currents on node 35.

Power switch elements 84 are configured to have fast switching speeds in order to accommodate the frequency of the AC motor 28. In an embodiment, the power switch elements 84 are Gallium Nitride (GaN) transistors, and switch at least an order of magnitude faster than a silicon MOSFET switch. The power switch elements 84 are coupled between the AC motor 28 and the filter 82, providing a path for the motor phase currents on nodes 35-1, 35-2, and 35-3. The digital control system 86 controls activation of the power switch elements 84, based on a command input, the position sensor feedback and the parameters associated with the AC motor, and control is exerted over the activation of the power switch elements 84 via the PWM 100. The parameters may be stored in non-volatile memory (NVM) 88. A change in any one of: the command input, the position sensor feedback and the parameters associated with the AC motor, triggers a change in the PWM 100 components, which triggers a change in activation of the power switch elements 84. As used herein, if “A” triggers “B”, then B is responsive to A. In an embodiment, controlling the activation of the power switch elements 84 further comprises separately controlling power switch elements 84, for example, by controlling (via the PWM 100 components) a sequence of activation for which the switch 84-1 drives node 35-1, the switch 84-2 drives the node 35-2, and the switch 84-3 drives the node 35-3. Current may travel into and out of the arrangement of power switch elements 84 via an internal RWA bus 31 and the spacecraft power bus 25

The filter 82 is configured to inhibit electrical noise and electromagnetic noise from being coupled between the spacecraft power bus 25 and the internal RWA bus 31. The required filter 82 size is also based on the AC motor 28 frequency and the pulse width modulators 100-1, 100-2, and 100-3. The required filter 82 size has an inverse relationship to the AC motor 28 frequency; as the AC motor 28 frequency is increased, the filter 82 size may be reduced. In addition, the filter 82 is configured based on the high dv/dt pulse width modulated (PWM) edges. In practice, locating the filter 82 as close as possible to the arrangement of power switch elements 84 may reduce the stress the AC motor 28 normally sees due to high frequency operation.

The individual current sensors 96-1, 96-2, and 96-3 (collectively current sensor 96) may comprise any commercially available current sensing device or technology. Individual current sensors 96-1, 96-2, and 96-3, may be located on the individual nodes 35-1, 35-2, and 35-3, respectively, coupled between the arrangement of power switch elements 84 and the AC motor 28. The current sensors 96 provide sensed current input(s) 49 to the analog to digital converter 92.

Individual digital isolators 98-1 to 98-7, collectively referred to as the digital isolator 98, provide galvanic isolation for the AC motor 28, the power switch elements 84, and spacecraft power bus 25. Ideally, the digital isolators 98-1 to 98-7 are strictly digital signal isolators, and do not pass any analog signals, even in the face of noise from the very high dv/dt pulse width modulated (PWM) signals generated by the digital control system 86. The depicted embodiment shows an individual digital isolator (98-1, 98-2, and 98-3) coupling the digital control system 86 to the individual power switch elements: switch 84-1, switch 84-2, and switch 84-3, respectively.

The temperature sensor 90 may be any commercially available temperature sensor suitable for the application. The temperature sensor 90 may sense temperature of the rotor in the AC motor 28 and provide rotor temperature input on node 47 to an analog to digital converter 92. The analog to digital converter 92 may be any commercially available analog to digital converter suitable for the application. The analog to digital converter 92 receives sensed analog signals via nodes 33, 49, and 47, and converts the sensed analog signals to respective digital signals, which are provided as input (at node 45) to the digital control system 86. Sensed rotor currents on node 49 of the AC motor 28 are collectively sensed from nodes 35-1, 35-2, and 35-3, and sensed current from the spacecraft power bus 25 is input on node 43.

Position sensor 94 senses a position of the rotor associated with the AC motor 28; that sensed position becomes a rotor position on the node 41. The position sensor 94 also senses a speed of the rotor that becomes a rotor speed at node 43. In operation, the position sensor 94 senses an analog signals on the node 37 and outputs a digital signal on the nodes 39-1, 39-2, and 39-3. In an embodiment, the position sensor 94 comprises the Hall sensor 94-1, the Hall sensor 94-2, and the Hall sensor 94-3. However, in other embodiments, the position sensor 94 may comprise one or more from the set including: analog sensors, optical encoders, resolvers, resistive devices, and magneto-resistive devices, and in various embodiments, the position sensor 94 may perform one or more position sensing schemes to produce or generate the required digital signal on the nodes 39-1, 39-2, and 39-3.

Turning attention again to the digital control system 86, the digital control system 86 comprises the digital signal processing components and modules for the motor controller 26. The functionality of the digital control system 86 can be performed by a variety of combinations of digital logic elements as known in the art, for example, FOCs, sinusoidal drives, and AC motor control algorithms. The digital control system 86 may further comprise one or more field programmable gate arrays (FPGA), Application Specific Integrated Circuits (ASIC), Digital Signal Processors (DSP), general purpose microcontrollers and microprocessors. Depending on the arrangement of components and modules within the digital control system 86, there may be one or more registers, memory management controls, data management controls, system timing and logic blocks arranged to perform the functions described herein. In the non-limiting example of FIG. 2, the digital control system 86 includes a FOC 108, a nonvolatile memory (NVM 88), a spacecraft interface and RWA control logic 110, a block comprising speed sense logic 106, a block comprising position estimator logic 104, an ADC driver and scaler 102, the pulse width modulators 100-1, 100-2, and 100-3, and a test interface 120. In other embodiments, the digital control system 86 comprises a Field Programmable Gate Array (FPGA) or an Application Specific Integrated Circuit (ASIC). The digital control system 86 may be buffered from analog signal processing in the remainder of the RWA 20 via the digital isolators 98. The digital control system 86 provides feedback (telemetry) as a data output command on lead 29 to a spacecraft control module 22 (for example, the status of the motor controller 26 and the AC motor 28).

The digital control system 86 stores parameters and variables associated with a plurality of AC motors in the NVM 88. The NVM 88 can include any known form of storage medium, or any type of memory technology, including any types of read-only memory or random access memory or any combination thereof. This encompasses a wide variety of media that include, for example but not limited to, an electronic, magnetic, optical, electromagnetic, infrared, or semiconductor system, apparatus, device, or propagation medium. In some embodiments, NVM 88 includes non-volatile, removable, and/or non-removable media, for example, random-access memory (RAM), read-only memory (ROM), electrically erasable programmable read-only memory (EEPROM), solid state memory or other memory technology, CD ROM, DVD, other optical disk storage, magnetic tape, magnetic disk storage or other magnetic storage devices, and any other medium that can be used to store desired data. For sake of simplicity of illustration, the NVM 88 is illustrated as a single block external to the digital control system 86; however, NVM 88 can be distributed and portions of it may be internal or external to the digital control system 86.

Non-limiting examples of parameters associated with each AC motor of the plurality of AC motors stored in NVM 88 include friction, torque constants, and maximum current. The NVM 88 may also store algorithms and variables for a variety of supported communication protocols, memory management protocols, and timing protocols. Based on a command input at lead 27, the position sensor feedback at nodes 33 and 35, and retrieved parameters associated with the AC motor 28, the digital control system 86 controls activation for the arrangement of power switch elements 84, (via the pulse width modulators 100-1, 100-2, and 100-3) and generates data output at lead 29. In an embodiment, the command input at lead 27 is a serial command input that has been user requested, and the data output at lead 29 is a serial data output.

The FOC 108 is coupled to pulse width modulators 100-1, 100-2, and 100-3 via nodes 52-1, 52-2, and 52-3 (collectively 52). In an embodiment, the pulse width modulators 100 perform pulse width modulation under control of the FOC 108. In one embodiment, the pulse width modulators 100-1, 100-2, and 100-3 perform spread-spectrum space vector pulse width modulation (SVPWM) and their output activates the arrangement of power switch elements 84 as described herein.

The FOC 108 is coupled to the spacecraft interface and RWA control logic 110, the speed sense logic 106, the position estimator logic 104, and the ADC driver and scaler 102 via node 53. The speed sense logic 106 determines a rotor speed of the AC motor 28 that may be communicated to external spacecraft control via the spacecraft interface and RWA control logic 110. The position estimator 104 receives the output from the position sensor 94, processes it, and communicates it to the FOC 108 and to the to external spacecraft control via the spacecraft interface and RWA control logic 110. The ADC 92 is configured to receive one or more from the set including: sensed spacecraft input power bus current on node 33, sensed motor phase currents on node 49, and sensed motor temperature on node 47. The ADC driver and scaler 102 is digitally isolated by 98-4 from the ADC 92. The ADC driver and scaler 102 scales and drives the signals received from the analog to digital converter 92 at node 45.

The spacecraft interface and RWA control logic 110 is coupled to the speed sense logic 106 via node 51. The speed sense module receives the rotor speed input on node 35 (e.g., hall sensor data) and converts that to speed information (e.g., RPM) which it also sends to the spacecraft interface and RWA control logic 110. The spacecraft interface and RWA control logic 110 may perform the function of accepting the user requested command protocol and configuring logic, timing, and data handling based thereon such that (i) generated data output at lead 29 meets the user requirement, and (ii) command input at lead 27 is received accordingly for use within the digital control system 86. In addition, the spacecraft interface and RWA control logic 110 conditions the data signals for the FOC 108.

FIG. 3 provides a flow chart for a method 300 for a high efficiency motor controller 26 of FIG. 2. In the provided motor controller 26 embodiment, the digital control system 86 executes an algorithm and associated rules, references NVM 88, and drives the arrangement of power switch elements in the performance of the method steps. As can be appreciated in light of the disclosure, the order of the method steps is not limited to the sequential execution illustrated in FIG. 3, rather the method steps may be performed in one or more varying orders as applicable, and in accordance with the present disclosure. As can further be appreciated, one or more steps of the method may be added or removed without altering the spirit of the process.

At 302 power is received from the spacecraft 10. At 304, initialization of components is performed, including detecting and identifying motor 28. At 306, parameters and variables associated with the identified motor 28 are retrieved. Subsequent to retrieval of the parameters and variables, an additional initialization may be performed, to set proper timing and data management. At 308 a communication protocol may be received. As previously mentioned, the communication protocol may be serial or parallel, and may be user supplied or be provided by the spacecraft 10. At 310, a command from the spacecraft 10 is received. At 312, motor control is generated. Output to the spacecraft, via lead 29, may occur at any time in the performance of the method 300, and may be initiated by input commands received on lead 27. In addition, current may travel between the spacecraft 10 and the motor controller 26, for example, within the spacecraft power bus 25.

Notably, the provided motor controller 26 may perform the full range of motor control, off-loading the spacecraft 10 of these duties. For example, the spacecraft 10 no longer has to “know” motor 28 features, such as bearing drag, of the specific motor 28 employed by any given RWA 20, process those features and then send motor control commands back to the RWA 20. This compartmentalization increases the ease of manufacturing and quality assurance. Accordingly, the provided motor controller 26 and controlled motor assembly 40 provides various technical effects, such as improving efficiency while reducing weight, parts count, size, and cost. In addition to the use with an RWA, the controlled motor assembly 40 may be combined with one or more from the set including: a linear position system, a gimbal mechanism, an antenna mechanism, and a fan for an Environmental Control and Life Support System (ECLSS).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A motor controller for use in a reaction wheel assembly (RWA) comprising:
An internal power bus filter configured to inhibit electrical and electromagnetic noise from being communicated between a spacecraft power bus associated with a spacecraft and a RWA internal power bus;
an arrangement of power switch elements providing a path for motor phase currents associated with an AC motor, the arrangement of power switch elements coupled between the AC motor and the RWA power bus;
a digital control system coupled to the AC motor and the arrangement of power switch elements, the digital control system configured to
receive a command input,
receive position sensor feedback associated with the AC motor,
retrieve parameters associated with the AC motor from a memory, and
based on the command input, the position sensor feedback and the parameters associated with the AC motor, (i) control activation of the arrangement of power switch elements, and (ii) generate a data output.

2. The motor controller of claim 1, wherein the parameters associated with the AC motor comprise torque constants and max current.

3. The motor controller of claim 2, wherein the position sensor feedback comprises a rotor position or a rotor speed associated with the AC motor.

4. The motor controller of claim 3, further comprising an analog to digital converter (ADC) coupling the position sensor feedback to the digital control system, the ADC configured to receive one or more from the set including: a sensed motor current, a sensed motor temperature, a sensed input power bus voltage, and a sensed internal voltage reference.

5. The motor controller of claim 4, wherein the AC motor is a high speed alternating current (AC) permanent magnet synchronous motor (PMSM).

6. The motor controller of claim 5, wherein the digital control system is configured to receive the command input in accordance with a user requested serial protocol.

7. The motor controller of claim 6, wherein the digital control system comprises one or more from the set including: a field oriented control (FOC), a sinusoidal drive, and an AC motor control algorithm.

8. The motor controller of claim 7, wherein the digital control system further comprises one or more from the set including: a field programmable gate array (FPGA), an Application Specific Integrated Circuit (ASIC), a Digital Signal Processor (DSP), a general purpose microcontroller, and a microprocessor.

9. The motor controller of claim 8, wherein the position sensor comprises one or more from the set including: a digital hall-effect sensor, a resolver, an analog sensor, a magneto-restrictive sensor, and an optical encoder.

10. A controlled motor assembly for use in a reaction wheel assembly (RWA), the controlled motor assembly comprising:
a filter coupled between a spacecraft power bus associated with a spacecraft and the RWA power bus, the filter configured to inhibit communication of electromagnetic noise between the spacecraft power bus the RWA power bus;
an AC motor configured to operate based on an input from the spacecraft;
an arrangement of power switch elements providing a path for motor phase currents, the arrangement of power switch elements coupled to the AC motor and the power bus internal to the RWA;
a digital control system coupled to the AC motor and the arrangement of power switch elements, the digital control system configured to:
receive a user requested communication protocol from among a plurality of supported communication protocols,
receive a command input in accordance with the user requested serial protocol,
receive a position sensor feedback associated with the AC motor,
retrieve parameters associated with the AC motor from a memory, and
based on the command input, the position sensor feedback and the parameters associated with the AC motor, control activation for the arrangement of power switch elements, and generate a serial telemetric output or a serial command-response output.

11. The controlled motor assembly of claim 10, wherein the parameters associated with the AC motor comprise torque constants and max current.

12. The controlled motor assembly of claim 11, wherein the position sensor feedback comprises a rotor position or a rotor speed associated with the AC motor.

13. The controlled motor assembly of claim 12, further comprising an analog to digital converter (ADC) coupling position sensor feedback to the digital control system, the ADC configured to receive one or more from the set including: a sensed motor current, a sensed motor temperature, a sensed input power bus voltage, and a sensed internal voltage reference.

14. The motor controller of claim 13, wherein the AC motor is a high speed alternating current (AC) permanent magnet synchronous motor (PMSM).

15. The controlled motor assembly of claim 14, wherein the digital control system comprises one or more from the set including: a field oriented control (FOC), a sinusoidal drive, and an AC motor control algorithm.

16. The controlled motor assembly of claim 15, wherein the digital control system further comprises one or more from the set including: a field programmable gate array (FPGA), an Application Specific Integrated Circuit (ASIC), a Digital Signal Processor (DSP), a general purpose microcontroller, and a microprocessor.

17. The controlled motor assembly of claim 16, wherein the position sensor comprises one or more from the set including: a digital hall-effect, a resolver, an analog sensor, a magneto-restrictive sensor, and an optical encoder.

18. The controlled motor assembly of claim 17, wherein the digital control system is further configured to control a sequence of activation of each power switch element of the arrangement of power switch elements.

19. The controlled motor assembly of claim 10, combined with one or more from the set including: a linear position system, a gimbal mechanism, an antenna mechanism, and a fan for an Environmental Control and Life Support System (ECLSS).

20. A reaction wheel assembly (RWA), comprising:
a rotor assembly; and
a controlled motor assembly comprising
a motor controller,
an AC motor configured to operate at a first frequency,
a filter coupling a spacecraft power bus associated with a spacecraft to the RWA power bus, the filter configured to inhibit electromagnetic noise at the first frequency from being coupled between the spacecraft power bus and a RWA power bus internal to the RWA;
an arrangement of power switch elements coupled between the AC motor and the filter, the arrangement of power switch elements configured (i) based on the first frequency, (ii) for providing a path for motor phase currents associated with the AC motor;
a digital control system coupled to the AC motor and the arrangement of power switch elements, the digital control system configured to:
receive a command input in a communication protocol requested by a user from among a plurality of supported communication protocols,
receive, from a position sensor, position feedback associated with the AC motor,
retrieve parameters associated with the AC motor from a nonvolatile memory, and
based on the command input, the position feedback and the parameters associated with the AC motor, control activation for the arrangement of power switch elements, and generate a serial telemetric output or a serial command-response output.
